(19) United States
(12) Patent Application Publication
(10) Pub. No.: US 2008/0263670 A1
(43) Pub. Date: Oct. 23, 2008

(54) Methods, software and apparatus for detecting and neutralizing viruses from computer systems and networks

(75) Inventor: Ovidiu Stavrica, Kenmore, WA (US)

Correspondence Address: GRAYBEAL, JACKSON, HALEY LLP, 155 - 108TH AVENUE NE, SUITE 350, BELLEVUE, WA, 98004-5973, US

(73) Assignee: Wiresoft Net, Inc., Cincinnati, OH (US)

(21) Appl. No.: 12/079,923

(22) Filed: Mar. 26, 2008

Related U.S. Application Data
(63) Continuation-in-part of application No. PCT/US2006/037499, filed on Sep. 26, 2006.
(60) Provisional application No. 60/720,945, filed on Sep. 26, 2005.

(51) Int. Cl. G06F 21/00

(52) U.S. Cl. 726/24

(57) ABSTRACT

Methods, software or computer programs, and apparatus for detecting viruses and mitigating their harm to computers communicating through a gateway node to another network are disclosed. Upon detection of a virus in an incoming data stream or plurality of data packets directed to a gateway device or node, the data requesting recipient is notified and provided with a plurality of pre-defined virus handling action options. If the recipient, or designated proxy, fails to select an action option, then a random selection is made. If a selection is made, then that selection, to the exclusion of other action options, is carried out. Thus, the recipient is empowered to dynamically select, as circumstances dictate and without future prejudice, the appropriate response upon detection of a particular virus. Action options may include data encryption and forwarding with recipient notification, or where email is the vector, attachment removal and location link insertion may be used. Software embodiments of the invention provide the machine readable instructions to carry out the methods according to the invention.

### BACKGROUND OF THE INVENTION

### Description of the Prior Art

The prior art details methods and apparatus for detecting and removing viruses and other malicious software programs during transmission of data over a protocol. By intercepting and neutralizing these common threats prior to reception of infected data by a data requesting computer, the requesting computer is insulated from the likely harmful consequence of infection. This method and related hardware/software, is generally referred to as a gateway solution. Gateway solutions are particularly beneficial in networked environments where the gateway services a plurality of client computers, such as in a business network. Gateway solutions usually employ proxy servers to facilitate the exchange of data between the clients within a trusted network and an outside network, such as the Internet.

Numerous patents have been issued for virus detection and remediation according to the previously described arrangement. U.S. Pat. Nos. 5,623,600 (“the '600 patent”) and 5,889,943 (“the '943 patent”) owned by Trend Micro, Inc. disclose such a gateway detection and remediation arrangement, and are incorporated herein by reference. While these noted patents disclose a variety of ways for detecting and addressing the virus threat, these ways are not exclusive nor the most advantageous.

### SUMMARY OF THE INVENTION

The present invention is directed to providing methods, software or computer programs, and apparatus for detecting viruses and mitigating their harm to computers communicating through a gateway node to another network. The term “viruses” as used herein comprises any intentionally or unintentionally requested or “pushed” data that would cause unintended or undesired consequences to the data receiving computer or computers linked thereto, and includes viruses, worms, trojans, spyware, malware, adware and logging programs among others. The term “gateway node” or “gateway” as used herein comprises a computer or a network that allows or controls access to another computer or network. Unless otherwise indicated herein, embodiments of the invention are preferably operative on or are carried out by the gateway(s), although output may be directed to, and input may be derived from, other computers on the network.

Methods according to certain embodiments of the invention comprise detecting the presence of a virus in an incoming data stream or plurality of data packets directed to a gateway device or node, notifying the intended recipient of the data stream or plurality of data packets that a virus has been detected, and providing the user with a plurality of pre-defined virus handling action options upon detection of a virus, from which the user may select or choose not respond. Notification preferably occurs through an application interface on the recipient computer that provides both the requisite notification function as well as response/selection capabilities.

If the intended recipient, or designated proxy, fails to select a pre-defined virus handling action option after a period of time (which may be constant or may be variably assigned), then a random selection from the plurality of action options is made without further intervention. However, if the intended recipient, or designated proxy, does make a selection, then that selection, to the exclusion of other action options, is carried out. In this manner, the intended recipient, or designated proxy, is empowered to select, as circumstances dictate, the appropriate response for a particular virus.

Thus, in some circumstances an intended recipient, or designated proxy, may be desirous of quarantining a detected virus for later analysis while in other circumstances the intended recipient, or designated proxy, may choose to eliminate the virus all together. This dynamic selection option provides enhanced flexibility and eliminates the requirement, common in the prior art, of having to pre-establish actions based upon as yet unknown viral threats.

In a preferred method embodiment according to the invention, one of the plurality of action options comprises encrypting the virus. Virus encryption effectively neutralizes the virus yet permits it to be “reanimated” should the user or subsequent party desire to analyze it. In this manner, the virus is not destroyed, may be further communicated to others, and yet remains viable for subsequent disposition. Moreover, the received data (a software executable program, for example) is not blocked in total. Instead, the offending code, or portion of offending code, is encrypted and the download of data may continue, which permits the user to likely operate the program. This feature is unlike certain methods in the prior art that completely terminate the download session or dispose of the entire data once downloaded. By analogy, this treatment by the prior art is like the proverbial throwing the baby out with the bath water.

An alternative action option comprises notifying the intended recipient of the virus detection and forwarding at least that portion of the data comprising the virus to a remote destination, such as the creator of the virus detection software. In this manner, mutations of a virus can be swiftly delivered to a third party for review and possible library or database updating.

The immediately preceding action options are useful for HTTP and FTP data transfer sessions. However, viral payloads often are associated with electronic mail messages that use, for example, SMTP. In these instances, an electronic mail message may have an encoded attachment that represents an executable or binary data set. The virus may be encoded in the data set or may be separately attached to the mail message. In such instances, an additional and non-limiting disposition action option includes removing all attachments from an incoming or outgoing electronic mail message, temporarily storing each attachment at a location within the network or gateway node, and including an inyocable link (for example an HTTP or FTP hypertext link) in the mail message that corresponds to each removed attachment. Thus, when the recipient of the mail message reviews the received mail message, he or she is presented with an opportunity to review the file associated with each presented link. To provide virus detection and remediation of the attachment(s), virus detection and remediation services associated with HTTP and/or FTP transfers are used instead of those that might otherwise be associated with SMTP functions. In this manner, scanning and remediation software already associated with these other protocols may be used to address electronic mail-based infections.

As the skilled practitioner will appreciate, SMTP is not the only electronic mail protocol: POP3 represents another common protocol for receiving electronic mail. However, POP3 servers and clients present situations and actions different from those of SMTP. While SMTP is a “push” service wherein the server delivers (or attempts to deliver) electronic mail without the participation of the SMTP client, POP3 services are based upon client polling requests—when a POP3 client issues a retrieve mail command, the POP3 server complies by delivering its stored mail. If no retrieve command is issued, all mail remains on the POP3 server.

Embodiments of the invention pertaining to POP3 electronic mail delivery rely upon a POP3 proxy operatively between the POP3 mail server and any mail clients in the network. In on series of embodiments, POP3 mail retrieve commands originating from a client are “intercepted” by the POP3 proxy, which in turn issues its own mail retrieve command to the remote POP3 server. As electronic mail is delivered to the POP3 proxy, any attachments to the electronic mail are extracted and scanned for viruses. If a virus or suspected virus is found, then the viral payload is treated as described above with respect to other viral instances at the gateway, or the user may select to include an irrevocable link to the stored file in the suspect mail message, where after the user (or any subsequent recipient) may link to the suspect file. Alternatively, the user may simply select, upon request, to replace the original file or electronic message (as the case may be) with a simple message that a virus was detected and that the sender of the message should be notified.

In another series of embodiments, when a POP3 mail client issues a “list” command in order to receive a list of electronic mail headers corresponding to mail files on the POP3 server, the POP3 proxy reissues this command to the POP3 mail server. In response to the command, the POP3 server returns the header list to the POP3 proxy. At or about the same time, evaluation of possible virus threats from the POP3 server that may be contained in any of the electronic mail corresponding to the delivered mail list is carried out. Any electronic mail identified as positive for a known (or suspected) threat is identified, and the POP3 proxy removes the header (list element) for that mail file from the mail list that is ultimately passed to the requesting mail client. As a consequence, the requesting mail client is only supplied with a list (and ultimately the corresponding mail messages) that have passed inspection by the scanner. As a consequence, the requesting client can only request and receive electronic mail messages that are known, a priori, to be virus free; the user is never presented with an opportunity to request a mail message that may have a virus (to the extent that the evaluation process can identify such threat).

In situations wherein there is a large volume of electronic mail on the POP3 server, embodiments of the invention provide for the POP3 proxy server to serially deliver “clean” headers to the mail client (as opposed to delivering a “clean” list in a batch form) in order to minimize the chance of a mail client time-out that might result if a response exceeds a predetermined period. In certain embodiments, at least some, and preferably all, electronic mail messages are cached on the POP3 proxy. By doing so, scan times and download times to the mail client can be materially reduced, thereby mitigating unwanted response time-outs.

Software embodiments of the invention provide the machine readable instructions to carry out the methods according to the invention. When the software is operatively installed and operating on a computer or appliance, the methods of the invention can be successfully carried out. Thus, a proxy firewall appliance, such as the WIRESOFT® Sentry gateway appliance, can be functionally between the Internet and a client computer where the appliance handles all protocol transfers between the client computer and the Internet. Such appliances have the benefit of utilizing basic computer hardware, e.g., memory, processor, network interface hardware, and operating software, e.g., Linux. Proxy server modules for each communications service, e.g., HTTP, FTP, SMTP and POP3 are installed and operative. From a user's perspective, the presence of the gateway appliance is transparent, yet robust virus protection is provided through means not subject to proprietary claims by third parties.

### BRIEF DESCRIPTION OF THE DRAWINGS

FIG. 1 is a process flow diagram illustrating the assessment of SMTP messages for viruses and possible actions based upon such assessment;

FIG. 2 is a process flow diagram illustrating the assessment of FTP data transfers for viruses and possible actions based upon such assessment;

FIG. 3 is a process flow diagram illustrating the assessment of POP3 messages for viruses and possible actions based upon such assessment; and

FIG. 4 is a process flow diagram illustrating an alternative assessment of POP3 messages for viruses and possible actions based upon such assessment

### DESCRIPTION OF THE PREFERRED EMBODIMENTS

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment shown, but is to be accorded the widest scope consistent with the principles and features disclosed herein.

As noted above, apparatus or system embodiments of the invention comprise a data sending server (hereinafter generally referred to as server “S” and having HTTP, FTP and SMTP applications operatively loaded and running thereon), a gateway device (hereinafter proxy server P having HTTP, FTP and SMTP applications, and embodiments of the invention operatively loaded and running thereon), and a data receiving server (hereinafter generally referred to as client “C” and having applications operatively loaded and running thereon to permit bidirectional communication with proxy server “P”). With respect to network communications (as opposed to communications via data discs), there are only several vectors available for exploitation. The common vectors include communication exchanges under the following protocols: SMTP, FTP, and POP3. Infection and remediation under each of these protocols will be described below.

Also described below is a computer application designated “DASHBOARD”. The purpose of DASHBOARD is to enable the gateway device or specifically proxy server “P” to instantaneously inform the administrator and select individual users whenever a virus is detected in a data stream or plurality of data packets passing through the gateway, as well as inform of actions taken in response to input or lack of input. DASHBOARD is further designed to enable the administrator and individual users to specify the action(s) to be taken on infected data. In certain embodiments, the DASHBOARD is the only means by which proxy server “P” can be instructed on what to do with infected data, other than refuse to pass it to client “C” (or any other client on the protected network). Embodiments of the invention may prevent client “C” access to proxy services if the DASHBOARD application is not confirmed running on client “C”.

A preferred embodiment for the DASHBOARD application is a JAVA compiled program able to execute within a web browser environment and/or natively on the recipient operating system. The gateway device preferably communicates with DASHBOARD using UDP packets in order to minimize network traffic while optimizing application simplicity. Other protocols such as TCP may also be used.

Conventional communications under SMTP has server “S” (sender) initiating a session with proxy server “P”. After an initial greeting and response, server “S” specifies the email address of the sender to proxy server “P”, which confirms receipt of the address. Server “S” then specifies its destination address(es), and proxy server “P” confirms receipt of destination address(es). Having addressed the formalities, server “S” then sends to proxy server “P” the email body, which comprises mail headers, dates, subject line, message text, and all attachments. Proxy server “P” confirms receipt of email body where after server “S” sends a ‘quit’ command and both servers terminate their session. Having met all requirements for a successful session, the SMTP PROXY residing on proxy server “P” redelivers the email message to the intended recipient such as client “C” in modes well known to the skilled practitioner.

The preceding paragraph illustrates a successful communications session. This is not always the case. If during the initial greeting with proxy server “P”, server “S” does not receive confirmation of initial greeting, a temporary or permanent error will result. Server “S” will then report a delivery failure back to proxy server “P”, and/or attempt to re-deliver the failed communication, as determined by its own runtime settings. Similar results occur if server “S” does not receive confirmation from proxy server “P” of its receipt of any one of the source address, the destination address, or the email body (comprising mail headers, dates, subject line, message text, and all attachments); server “S” will either report a delivery failure back to the sender, or attempt to re-deliver, as determined by its own runtime settings. In either event, server “S” sends ‘quit’ command (both servers terminate session) and no message or portion thereof is delivered to any destination mail server.

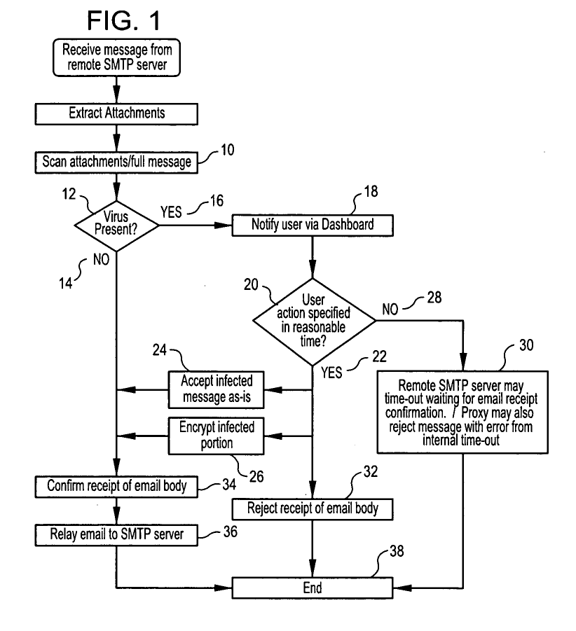

In situations when an embodiment of the invention is operatively running on proxy server “P” and virus detection and remediation is desired, the process flow according to FIG. 1 takes place. As shown, FIG. 1 presumes that proxy server “P” has successfully received all required data necessary to forward the email to the recipient SMTP server or client “C” (the end user or the at least one client computer). However, instead of acknowledging receipt by proxy server “P” to server “S” of the email body 34, virus assessment 12 takes place. If the assessment fails to reveal the presence of any virus 14, then a confirmation receipt is issued 34, which ends the sessions 38 between server S and proxy server “P”, and proxy server “P” relays the email to the recipient SMTP server 36 or client “C”.

However, if a virus is detected 16, then proxy server “P” notifies the network administrator and the intended recipient of the virus detection via DASHBOARD application 18 and presents several response options 24, 26, and 32. As noted, the administrator or recipient can elect to accept the infected email body in an unaltered form 24 or portion thereof, encrypt the infected portion of the email body or the entire email body for delivery 26, or reject the email body in its entirety 32. While not shown, additional operations are available, and include forwarding the infected data (either all or a portion thereof) to a third party in either an encrypted or unencrypted state.

In an alternative embodiment not shown, proxy server “P” can send an HTML or equivalently encoded message to the intended recipient client “C”, providing the noted choices. Selection of an HTML link would then provide the necessary instructions to proxy server “P” to enable it to carry out the affirmatively requested action.

A feature of the described embodiment is that it operates in a failsafe mode. Thus, if no affirmative action 20 is issued in response to the DASHBOARD notice 18 (or to the HTML encoded message), either server “S” will timeout due to its lack of receiving confirmation of proxy server “P”'s receipt of the email body, or proxy server “P” will timeout and reject the email. In circumstances wherein there is a timeout or the email is otherwise questioned, the email received by proxy server “P” will not be delivered to the recipient SMTP server and will be removed from proxy server “P”'s cache in due course. This state ensures that unless there is an affirmative action by client “C” or the system administrator, any infected data will be prevented from passing through proxy server “P”. Preferably, client “C” is notified of the status of the transfer request, and an administrative log is updated as well.

A similar challenge and response format is applied to File Transfer Protocol sessions. These sessions utilize two kinds of connections: command and data. Command connections are used to exchange commands such as “RETR”, “STOR”, “DELETE” . . . etc. Data connections are used to transfer the actual file contents. FTP support two (2) kinds of data transfer processes (DTP): active and passive. The following discussion below deals with the data connection, as utilized by both the active and passive data transfer processes, although typically a DTP will be either one or the other during an FTP session.

Under normal conditions, a client “C” connects to proxy server “P”, which in turn connects to server “S” wherein the desired data resides. Client “C” authenticates to proxy server “P”, which in turn authenticates to server “S”. Client “C” then sends a RETR or STOR command to proxy server “P”, which passes the same command to server “S” over a command connection. The RETR command causes server “S” to open a data connection back to proxy server “P”, and send the requested file to proxy server “P” over the data connection. In this manner, the data contents of the file are sent to proxy server “P”, which confirms the validity of the file, verifies its ability to read the temporary file, etc. Proxy server “P” then retransmits the data via another data connection to client “C”, where after client “C” closes the control connection with proxy server “P”, and any temporary files present there on are automatically deleted. At that time, proxy server “P” closes its control connection with Server “S”.

As with SMTP communications, numerous required exchanges can fail, which result in the requested data file not being transmitted to client “C”. In some instances client “C” is notified of the failure in specific terms, while in other instances the transfer is merely aborted with little or no explanation. The DASHBOARD application can provide the necessary messaging means although other services such as SNMP may provide the desired level of functionality.

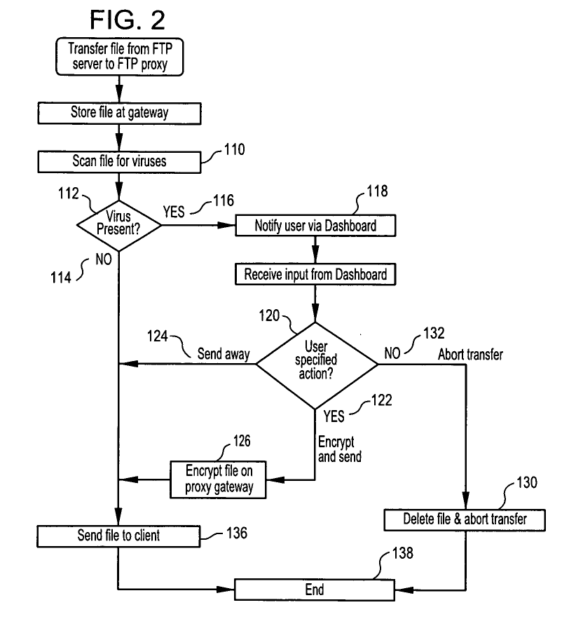

In situations when an embodiment of the invention is operatively running on proxy server “P” and virus detection and remediation is desired, the process flow according to FIG. 2 takes place. As shown, FIG. 2 presumes that proxy server “P” has successfully received all required data necessary to forward to client “C” (the end user or the at least one client computer). Before sending the transferred file to client “C” 136, the stored file is scanned for viruses 110. If the virus scan fails to reveal the presence of any virus 114, then the scanned file is sent to client “C” under normal proxy server protocols 136 and the session ends 138.

However, if a virus is present 116, then proxy server “P” notifies the network administrator and the intended recipient of the virus detection via the DASHBOARD application 118 and presents several response options 124, 126, and 132. As noted, the administrator or recipient can elect to send the infected data in an unaltered form 124 or portion thereof, encrypt the infected data or malicious portion thereof for delivery 126, or abort the transfer in its entirety 132. While not shown, additional operations are available, and include forwarding the infected data (either all or a portion thereof) to a third party in either an encrypted or unencrypted state.

A feature of the described embodiment is that proxy server “P” operates in a failsafe mode. Thus, if no affirmative action is issued 120 in response to the DASHBOARD notice 118 (or to an HTML encoded message, for example), the transfer will be aborted and the file deleted 130. This state ensures that unless there is an affirmative action by client “C” or the system administrator, any infected data will be prevented from passing through proxy server “P”. Preferably, client “C” is notified of the status of the transfer request, and an administrative log is updated as well.

Finally, embodiments of the invention will find utility in the POP3 environment. Here, client “C” connects to proxy server “P”, which in turn connects to server “S”. Client “C” then authenticates to proxy server “P”, which authenticates to server “S”. To initiate a POP3 session, client “C” requests a message (“RETR N”, where N is message id) and proxy server “P” relays the message retrieval request to Server “S”, which then transfers a first message in its entirety to proxy server “P”. As with other protocols, any failure in communication or authentication will result in an error message being generated and termination of the session. In some instances client “C” is notified of the failure in specific terms, while in other instances the transfer is merely aborted with little or no explanation. The DASHBOARD application can provide the necessary messaging means although other services such as SNMP may provide the desired level of functionality.

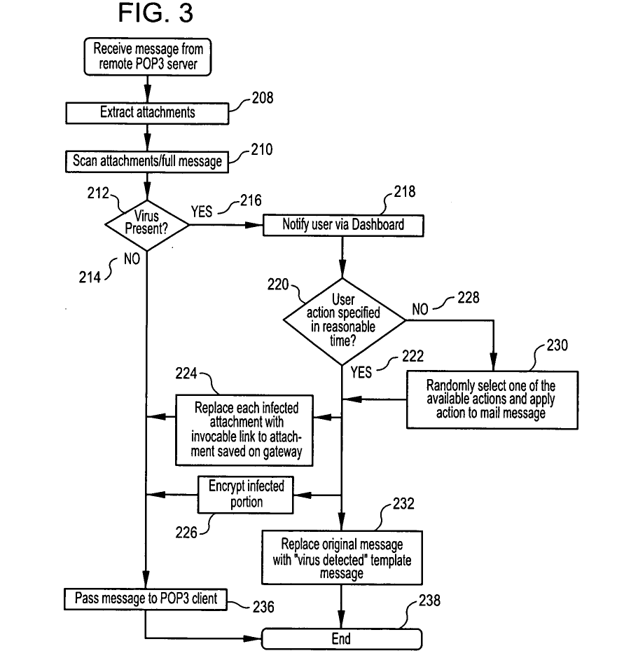

In situations when an embodiment of the invention is operatively running on proxy server “P” and virus detection and remediation is desired, the process flow according to FIG. 3 takes place. As shown, FIG. 3 presumes that proxy server P has successfully received all required data necessary to forward to client “C” (the end user or the at least one client computer). Before sending the message to client “C” 236, the temporarily stored message is parsed for attachments 208 and both attachment(s) and the text message are scanned for viruses 210. If the virus scan fails to reveal the presence of any virus 214, then the scanned message and any attachment(s) are sent to client “C” under normal proxy server protocols 236 and the session ends 238.

However, if a virus is present 216, then proxy server “P” notifies the network administrator and the intended recipient of the virus detection via the DASHBOARD application 218 and presents several response options 224, 226, and 232. Here, the administrator or recipient can elect to replace each infected attachment with an invocable link to the attachment, which is sequestered on proxy server P 224, encrypt the infected data or malicious portion thereof for delivery 226, or delete the infected attachment in its entirety, and append the message with a “virus detected” message 232 (alternatively, the entire email body can be replaced with a generated message). While not shown, additional operations are available, and include forwarding the infected data (either all or a portion thereof to a third party in either an encrypted or unencrypted state. In addition, the affirmative selection requirement inherent in the DASHBOARD application can be solicited via an HTML message or equivalent means.

A feature of the described embodiment is that proxy server “P” operates in a failsafe mode. Thus, if no affirmative action 220 is issued in response to the DASHBOARD notice 218 (or to an HTML encoded message, for example), the transfer may be aborted and the file deleted, or one of the affirmative options may be randomly applied 230. This state ensures that unless there is an affirmative action by client “C” or the system administrator, any infected data will be prevented from passing through proxy server “P” in an undesired state. Preferably, client “C” is notified of the status of the transfer request, and an administrative log is updated as well.

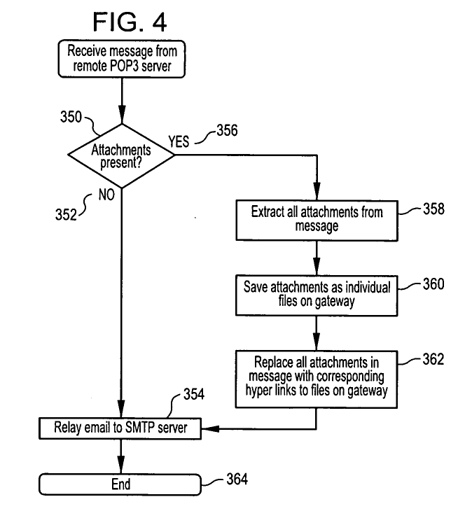

An alternative POP3 solution can also be applied, which is best shown in FIG. 4. In this alternative embodiment, all message are assessed for attachments 350, and the attachments are extracted 358 and saved as individual files on proxy server P 360. The original messages are converted to HTML messages (if not already HTML messages) and hyperlinks to the formerly present attachments are appended to the email body 362. The modified HTML messages are then sent to the SMTP proxy service for delivery to the intended recipient 354. A similar approach can be undertaken with respect to the SMTP proxy server.

Because textual messages are rarely viable vectors for viruses, this alternative embodiment beneficially removes the attachments from messages that are suitable vectors, and processes them under FTP.

What is claimed:

1. In a computer network environment comprising a gateway device operatively coupled to and between at least one client computer and a data communications network having an originating computer, a method for detecting and neutralizing an electronic virus directed to the gateway device comprises:
a) upon receiving a request from at least one client computer by the gateway device, issuing a request for a data stream or plurality of data packets from the public data communications network;
b) receiving the requested data stream or plurality of data packets at the gateway device;
c) temporarily storing and scanning the data stream or plurality of data packets for at least one virus or indicator of malicious content;
d) notifying at least one client computer that a virus or indicator of malicious content has been detected;
e) presenting the notified client computer with a plurality of virus handling action options for selection by the operator thereof; and
f) one of performing the selected virus handling action option, randomly selecting one of the plurality of virus handling action options or doing nothing.

2. The method of claim 1 wherein the plurality of virus handling action options comprises encrypting at least that portion of the data stream or plurality of data packets comprising the virus.

3. The method of claim 1 wherein the plurality of virus handling action options comprises forwarding at least that portion of the data stream or plurality of data packets comprising the virus to a remote destination.

4. The method of claim 1 wherein the plurality of virus handling action options comprises replacing at least that portion of the data stream or plurality of data packets comprising the virus with a computer readable link to where the removed data can be found.

5. The method of claim 1 wherein the random selection of one of the plurality of virus handling action options occurs if there is no selection of any virus handling action option by the operator.

6. The method of claim 1 wherein nothing is done if there is no selection of any virus handling action option by the operator.

7. The method of claim 1 wherein the plurality of virus handling action options comprises notifying the originating computer that the data stream or plurality of data packets has not been received.

8. The method of claim 1 wherein notification of the at least one client computer uses User Datagram Protocol (UDP).

9. The method of claim 1 wherein the data stream or plurality of data packets is sent in Hyper Text Transfer Protocol (HTTP).

10. The method of claim 1 wherein the data stream or plurality of data packets is sent in File Transfer Protocol (FTP).

11. The method of claim 1 wherein the data stream or plurality of data packets is sent in Simple Mail Transfer Protocol (SMTP).

12. The method of claim 1 wherein the originating computer comprises a POP3 server and only those portions of the data stream or plurality of data packets wherein a virus or indicator of malicious content has not been detected are indicating to the client computer as available for transfer thereto.

13. The method of claim 1 wherein the originating computer comprises a POP3 server, the data stream or plurality of data packets encode electronic mail messages, the temporary storing and scanning applies only to attachment portions of the electronic mail messages, and replacing at least some of the attachments with a computer readable link to where the removed data can be found.

14. The method of claim 13 wherein all attachments are replaced with a computer readable link to where the removed data can be found.

15. The method of claim 13 wherein only those attachments comprising the virus are replaced with a computer readable link to where the removed data can be found.
